(19) United States
(12) Patent Application Publication
(10) Pub. No.: US 2025/0085559 A1
(43) Pub. Date: Mar. 13, 2025

(54) COMBINED MONOLITHIC UNIFORM LIGHTING DEVICE BASED ON LENSES AND SAWTOOTH GRATINGS

(71) Applicants: Glory Light Technology (Harbin) Co., Ltd., Harbin (CN); Harbin Institute of Technology, Harbin (CN)

(72) Inventors: Jian Liu, Harbin (CN); Xumin Ding, Harbin (CN); Xinwei Wang, Harbin (CN)

(21) Appl. No.: 18/583,154

(22) Filed: Feb. 21, 2024

(30) Foreign Application Priority Data
Sep. 13, 2023 (CN) 202311182994.9

(51) Int. Cl. G02B 27/09; G02B 5/18

(52) U.S. Cl. CPC G02B 27/0961; G02B 5/1823; G02B 5/1871; G02B 27/0944

(57) ABSTRACT

Provided is a combined monolithic uniform lighting device based on lenses and sawtooth gratings. The present invention aims to solve the problem that traditional light absorption curtains cannot ensure that the natural light at each lighting stage can be evenly scattered into a room, making it difficult to form an all-weather uniform sunshine effect. The device includes ten first thin light sheets, ten second thin light sheets, ten third thin light sheets, ten fourth thin light sheets, ten fifth thin light sheets, ten sixth thin light sheets, ten seventh thin light sheets, ten eighth thin light sheets, ten ninth thin light sheets and ten tenth thin light sheets, which are arranged in a matrix to form a daylighting matrix.

### TECHNICAL FIELD

The present invention belongs to the technical field of optics, and relates to a uniform lighting device.

### BACKGROUND

Research and development of natural light lighting technology in China started in the 1960s and 1970s. After the “Green Lighting” Program has been launched since 1996, the green energy concept of natural light lighting has gradually come into the public view. With continuous in-depth research on the solar lighting technology, people also have an in- depth understanding of the natural light collection and lighting systems. The intensity and angle of direct sunlight throughout a day are different due to different moments in the morning and evening. People can divide the changes in direct sunlight throughout the day into three lighting stages according to different angles between the sun and the ground:
1. sunlight in the morning and evening: when the sun rises from the eastern horizon, and when sun is about to set below the horizon in the west, an angle between the sun and the ground into falls within 0°-15°;
2. the sunlight in the morning and afternoon: an angle between the sunlight in the morning and evening and the ground falls within 15°-60°, which usually refers to the light from 8 a.m. to 11 a.m., and the light from 2 p.m. to 5 p.m. in the afternoon, with relatively stable lighting intensity; and
3. the sunlight at noon: also known as the top light, strikes the ground vertically from top to bottom, and a lighting angle of the sunlight at this moment is often affected by the season. At noon in summer, the sunlight basically strikes the ground scene at an angle of 90° vertically, and the ground scene produces very limited projection. While at noon in other seasons, the sunlight shines from top to bottom at a nearly vertical angle, and at noon in winter, the lighting angle of the sunlight is more skewed.

The natural light at the above three lighting stages enters a room at different angles. Traditional daylighting curtains cannot ensure that the natural light at each lighting stage can be evenly scattered into the room, making it difficult to form an all-weather uniform sunshine effect.

### SUMMARY

In order to solve the problem that traditional light absorption curtains cannot ensure that the natural light at each lighting stage can be evenly scattered into a room, making it difficult to form an all-weather uniform sunshine effect, the present invention provides a combined monolithic uniform lighting device based on lenses and sawtooth gratings.

In order to solve the above problems, the present invention adopts the following technical solution: the present invention includes ten first thin light sheets, ten second thin light sheets, ten third thin light sheets, ten fourth thin light sheets, ten fifth thin light sheets, ten sixth thin light sheets, ten seventh thin light sheets, ten eighth thin light sheets, ten ninth thin light sheets and ten tenth thin light sheets, which are arranged in a matrix to form a daylighting matrix;
a first row of the daylighting matrix includes a first thin light sheet, a second thin light sheet, a third thin light sheet, a fourth thin light sheet, a fifth thin light sheet, a sixth thin light sheet, a seventh thin light sheet, an eighth thin light sheet, a ninth thin light sheet, and a tenth thin light sheet in order from left to right;
a second row of the daylighting matrix includes a tenth thin light sheet, a first thin light sheet, a second thin light sheet, a third thin light sheet, a fourth thin light sheet, a fifth thin light sheet, a sixth thin light sheet, a seventh thin light sheet, an eighth thin light sheet, and a ninth thin light sheet in order from left to right;
a third row of the daylighting matrix includes a ninth thin light sheet, a tenth thin light sheet, a first thin light sheet, a second thin light sheet, a third thin light sheet, a fourth thin light sheet, a fifth thin light sheet, a sixth thin light sheet, a seventh thin light sheet, and an eighth thin light sheet in order from left to right;
a fourth row of the daylighting matrix includes an eighth thin light sheet, a ninth thin light sheet, a tenth thin light sheet, a first thin light sheet, a second thin light sheet, a third thin light sheet, a fourth thin light sheet, a fifth thin light sheet, a sixth thin light sheet, and a seventh thin light sheet in order from left to right;
a fifth row of the daylighting matrix includes a seventh thin light sheet, an eighth thin light sheet, a ninth thin light sheet, a tenth thin light sheet, a first thin light sheet, a second thin light sheet, a third thin light sheet, a fourth thin light sheet, a fifth thin light sheet, and a sixth thin light sheet in order from left to right;
a sixth row of the daylighting matrix includes a sixth thin light sheet, a seventh thin light sheet, an eighth thin light sheet, a ninth thin light sheet, a tenth thin light sheet, a first thin light sheet, a second thin light sheet, a third thin light sheet, a fourth thin light sheet, and a fifth thin light sheet in order from left to right;
a seventh row of the daylighting matrix includes a fifth thin light sheet, a sixth thin light sheet, a seventh thin light sheet, an eighth thin light sheet, a ninth thin light sheet, a tenth thin light sheet, a first thin light sheet, a second thin light sheet, a third thin light sheet, and a fourth thin light sheet in order from left to right;
an eighth row of the daylighting matrix includes a fourth thin light sheet, a fifth thin light sheet, a sixth thin light sheet, a seventh thin light sheet, an eighth thin light sheet, a ninth thin light sheet, a tenth thin light sheet, a first thin light sheet, a second thin light sheet, and a third thin light sheet in order from left to right;
a ninth row of the daylighting matrix includes a third thin light sheet, a fourth thin light sheet, a fifth thin light sheet, a sixth thin light sheet, a seventh thin light sheet, an eighth thin light sheet, a ninth thin light sheet, a tenth thin light sheet, a first thin light sheet, and a second thin light sheet in order from left to right;
a tenth row of the daylighting matrix includes a second thin light sheet, a third thin light sheet, a fourth thin light sheet, a fifth thin light sheet, a sixth thin light sheet, a seventh thin light sheet, an eighth thin light sheet, a ninth thin light sheet, a tenth thin light sheet, and a first thin light sheet in order from left to right;
outer side surfaces of the first thin light sheets, the second thin light sheets, the third thin light sheets, the fourth thin light sheets, the fifth thin light sheets, the sixth thin light sheets, the seventh thin light sheets, the eighth thin light sheets, the ninth thin light sheets, and the tenth thin light sheets are all continuous lens arrays, and inner side surfaces of the first thin light sheets, the second thin light sheets, the third thin light sheets, the fourth thin light sheets, the fifth thin light sheets, the sixth thin light sheets, the seventh thin light sheets, the eighth thin light sheets, the ninth thin light sheets, and the tenth thin light sheets are all continuous sawtooth gratings;
an angle between a sawtooth line of a sawtooth grating on an inner surface of the first thin light sheet and a horizontal plane is 50°;
an angle between a sawtooth line of a sawtooth grating on an inner surface of the second thin light sheet and a horizontal plane is 30°;
an angle between a sawtooth line of a sawtooth grating on an inner surface of the third thin light sheet and a horizontal plane is 20°;
an angle between a sawtooth line of a sawtooth grating on an inner surface of the fourth thin light sheet and a horizontal plane is 10°;
an angle between a sawtooth line of a sawtooth grating on an inner surface of the fifth thin light sheet and a horizontal plane is 5°;
an angle between a sawtooth line of a sawtooth grating on an inner surface of the sixth thin light sheet and a horizontal plane is 175°;
an angle between a sawtooth line of a sawtooth grating on an inner surface of the seventh thin light sheet and a horizontal plane is 170°;
an angle between a sawtooth line of a sawtooth grating on an inner surface of the eighth thin light sheet and a horizontal plane is 160°;
an angle between a sawtooth line of a sawtooth grating on an inner surface of the ninth thin light sheet and a horizontal plane is 150°; and
an angle between a sawtooth line of a sawtooth grating on an inner surface of the tenth thin light sheet and a horizontal plane is 130°.

Further, the continuous lens arrays refer to continuous concave lens arrays.

Further, a thickness z₁ of different positions x₁ and y₁ on a surface of each concave lens of the continuous concave lens arrays is expressed as

$${z}_{1} = - \frac{{x}_{1}^{2} + {y}_{1}^{2}}{{r}_{1} + \sqrt{{r}_{1}^{2} - ( {x}_{1}^{2} + {y}_{1}^{2} )}} ,$$

where r₁ is a radius of curved surface of a concave lens, and the radius of curved surface is 1-5 times a minimum spacing between the concave lens and a sawtooth grating.

Further, a phase modulation φ₁ added to natural light by the continuous concave lens arrays is expressed as

$${φ}_{1} = - \frac{π ( {x}_{3}^{2} + {y}_{3}^{2} )}{λ f} ,$$

where x₃ and y₃ are positions of an incident wavefront of the lens arrays, λ represents a center wavelength of the natural light, and f represents a focal length of the lens.

Further, the continuous lens arrays refer to continuous convex free-form surface lens arrays.

Further, a thickness d₁ of different positions x₁ and y₁ on each convex free-form surface of the continuous convex free-form surface lens arrays is expressed as

$${d}_{1} ( {x}_{1} , {y}_{1} ) = \frac{1}{n - 1} ( \frac{{x}_{1}^{2} + {y}_{1}^{2}}{{r}_{1} + \sqrt{{r}_{1}^{2} + ( {x}_{1}^{2} + {y}_{1}^{2} )}} + {y}_{1} \cdot sin {θ}_{1} ) ,$$

where n represents a refractive index, r₁represents a radius of curvature at a vertex of the convex free-form surface, and θ₁ represents a surface-type inclination angle of the convex free-form surface, which makes the light propagate in a horizontal direction through refraction, and the radius of curvature is 1-5 times a minimum spacing between the free-form surface and the sawtooth grating.

Further, a phase modulation φ₁ added to incident light by the continuous convex free-form surface lens arrays is expressed as

$${φ}_{1} = - \frac{π ( {x}_{3}^{2} + {y}_{3}^{2} )}{λ {f}_{1}} - \frac{2 π}{λ} {y}_{3} \cdot sin {θ}_{3} ,$$

where θ₃ represents an incident angle of the natural light on the free-form surface, λ represents a center wavelength of the incident light, f₁ represents an equivalent focal length of the free-form surface, and x₃ and y₃ are positions of an incident wavefront of free-form surface arrays.

Further, a phase modulation φ₂ added to incident natural light by the continuous sawtooth gratings is expressed as

$${φ}_{2} = - \frac{2 π}{λ} {y}_{4} \cdot sin {θ}_{4} ,$$

wherein y₄ represents a position of an incident wavefront of the sawtooth surface array, and θ₄ represents an incident angle of natural light on a sawtooth surface.

Further, the first thin light sheets, the second thin light sheets, the third thin light sheets, the fourth thin light sheets, the fifth thin light sheets, the sixth thin light sheets, the seventh thin light sheets, the eighth thin light sheets, the ninth thin light sheets and the tenth thin light sheets are all made of transparent materials with a transmittance greater than 85%.

Further, each lens of the continuous lens arrays corresponds to each sawtooth of the sawtooth gratings of the continuous sawtooth gratings, a center position of the sawtooth matches an optical axis of the lens, and a range of an sawtooth inclination angle of the continuous gratings θ is 20°-70°.

The present invention has the beneficial effects:
1. the present invention can absorb the natural light at each outdoor lighting stage, and evenly scatter the natural light to every corner of a room, forming uniform lighting without any blind area;
2. the present invention is not subject to limitations of the illumination angle of the outdoor natural light, and can completely collect the natural light at different incident angles at each time period and evenly scatter the light indoors to form uniform lighting of the natural light and achieve full utilization of green energy;
3. the present invention can replace traditional curtains, blockout curtains, windows, and the like to protect indoor privacy and prevent outdoor prying into the room;
4. the present invention adopts lightweight design concept, featuring light overall weight and easy to mass production; and
5. the present invention can efficiently collect the natural light incident into the window, disperse the light evenly to all directions indoors, homogenize the indoor lighting, and effectively protect the indoor privacy, and the device is thin and easy to mass production, environmentally friendly and pollution-free.

### BRIEF DESCRIPTION OF THE DRAWINGS

FIG. 1 is a schematic diagram of a front structure of the present invention.

FIG. 2 is a side view of thin light sheets when outer side surfaces of the thin light sheets are continuous concave lens arrays.

FIG. 3 is a side view of thin light sheets when outer side surfaces of the thin light sheets are continuous free-form surface lens arrays.

FIG. 4 is a schematic view of an inner side surface of a first thin light sheet.

FIG. 5 is a schematic view of an inner side surface of a second thin light sheet.

FIG. 6 is a schematic view of an inner side surface of a third thin light sheet.

FIG. 7 is a schematic view of an inner side surface of a fourth thin light sheet.

FIG. 8 is a schematic view of an inner side surface of a fifth thin light sheet.

FIG. 9 is a schematic view of an inner side surface of a sixth thin light sheet.

FIG. 10 is a schematic view of an inner side surface of a seventh thin light sheet.

FIG. 11 is a schematic view of an inner side surface of an eighth thin light sheet.

FIG. 12 is a schematic view of an inner side surface of a ninth thin light sheet.

FIG. 13 is a schematic view of an inner side surface of a tenth thin light sheet.

### DETAILED DESCRIPTION OF THE EMBODIMENTS

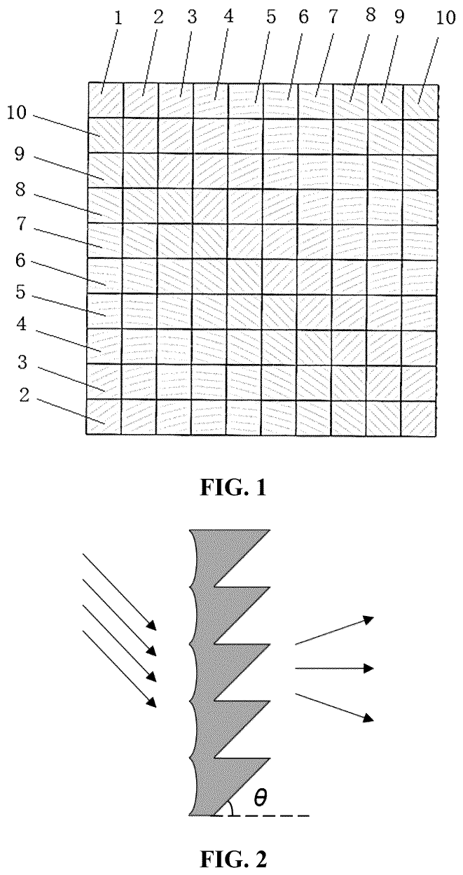

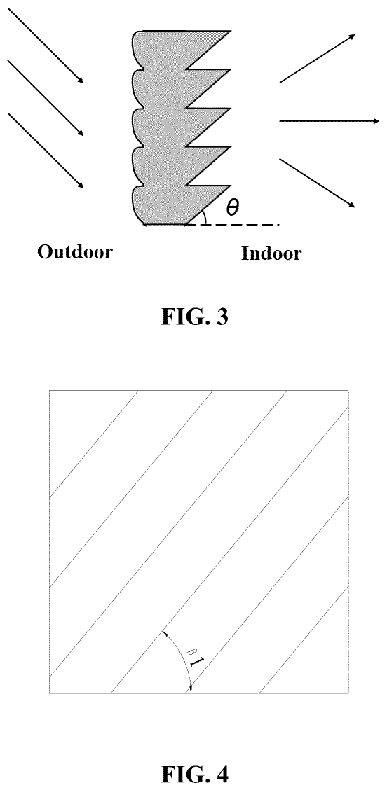

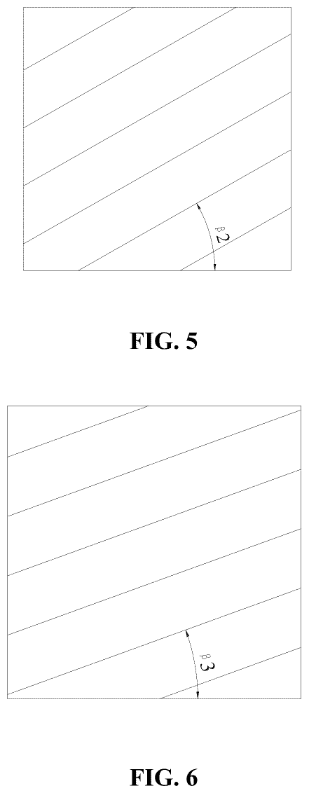

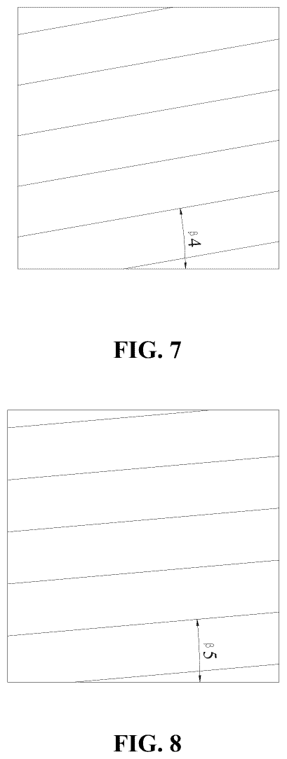

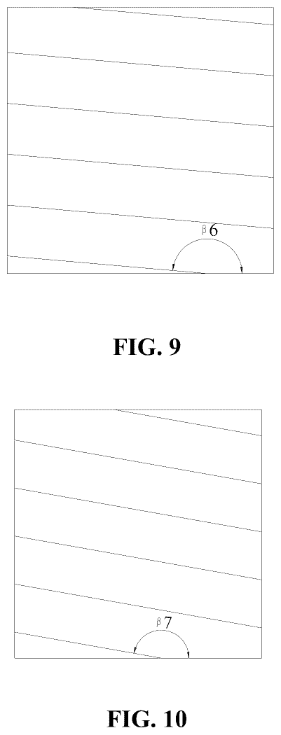

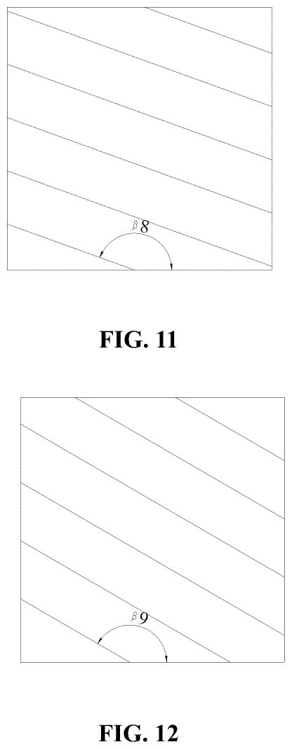

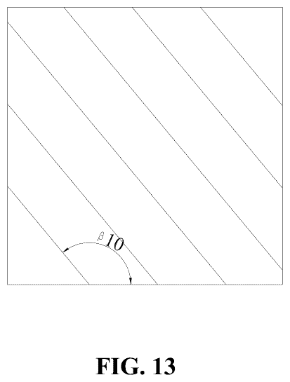

Specific Embodiment 1: this embodiment will be described in conjunction with FIGS. 1-13, where a combined monolithic uniform lighting device based on light sheets and sawtooth gratings provided in this embodiment includes ten first thin light sheets 1, ten second thin light sheets 2, ten third thin light sheets 3, ten fourth thin light sheets 4, ten fifth thin light sheets 5, ten sixth thin light sheets 6, ten seventh thin light sheets 7, ten eighth thin light sheets 8, ten ninth thin light sheets 9 and ten tenth thin light sheets 10, which are arranged in a matrix to form a daylighting matrix;
a first row of the daylighting matrix includes a first thin light sheet 1, a second thin light sheet 2, a third thin light sheet 3, a fourth thin light sheet 4, a fifth thin light sheet 5, a sixth thin light sheet 6, a seventh thin light sheet 7, an eighth thin light sheet 8, a ninth thin light sheet 9, and a tenth thin light sheet 10 in order from left to right;
a second row of the daylighting matrix includes a tenth thin light sheet 10, a first thin light sheet 1, a second thin light sheet 2, a third thin light sheet 3, a fourth thin light sheet 4, a fifth thin light sheet 5, a sixth thin light sheet 6, a seventh thin light sheet 7, an eighth thin light sheet 8, and a ninth thin light sheet 9 in order from left to right;
a third row of the daylighting matrix includes a ninth thin light sheet 9, a tenth thin light sheet 10, a first thin light sheet 1, a second thin light sheet 2, a third thin light sheet 3, a fourth thin light sheet 4, a fifth thin light sheet 5, a sixth thin light sheet 6, a seventh thin light sheet 7, and an eighth thin light sheet 8 in order from left to right;
a fourth row of the daylighting matrix includes an eighth thin light sheet 8, a ninth thin light sheet 9, a tenth thin light sheet 10, a first thin light sheet 1, a second thin light sheet 2, a third thin light sheet 3, a fourth thin light sheet 4, a fifth thin light sheet 5, a sixth thin light sheet 6, and a seventh thin light sheet 7 in order from left to right;
a fifth row of the daylighting matrix includes a seventh thin light sheet 7, an eighth thin light sheet 8, a ninth thin light sheet 9, a tenth thin light sheet 10, a first thin light sheet 1, a second thin light sheet 2, a third thin light sheet 3, a fourth thin light sheet 4, a fifth thin light sheet 5, and a sixth thin light sheet 6 in order from left to right;
a sixth row of the daylighting matrix includes a sixth thin light sheet 6, a seventh thin light sheet 7, an eighth thin light sheet 8, a ninth thin light sheet 9, a tenth thin light sheet 10, a first thin light sheet 1, a second thin light sheet 2, a third thin light sheet 3, a fourth thin light sheet 4, and a fifth thin light sheet 5 in order from left to right;
a seventh row of the daylighting matrix includes a fifth thin light sheet 5, a sixth thin light sheet 6, a seventh thin light sheet 7, an eighth thin light sheet 8, a ninth thin light sheet 9, a tenth thin light sheet 10, a first thin light sheet 1, a second thin light sheet 2, a third thin light sheet 3, and a fourth thin light sheet 4 in order from left to right;
an eighth row of the daylighting matrix includes a fourth thin light sheet 4, a fifth thin light sheet 5, a sixth thin light sheet 6, a seventh thin light sheet 7, an eighth thin light sheet 8, a ninth thin light sheet 9, a tenth thin light sheet 10, a first thin light sheet 1, a second thin light sheet 2, and a third thin light sheet 3 in order from left to right;
a ninth row of the daylighting matrix includes a third thin light sheet 3, a fourth thin light sheet 4, a fifth thin light sheet 5, a sixth thin light sheet 6, a seventh thin light sheet 7, an eighth thin light sheet 8, a ninth thin light sheet 9, a tenth thin light sheet 10, a first thin light sheet 1, and a second thin light sheet 2 in order from left to right;
a tenth row of the daylighting matrix includes a second thin light sheet 2, a third thin light sheet 3, a fourth thin light sheet 4, a fifth thin light sheet 5, a sixth thin light sheet 6, a seventh thin light sheet 7, an eighth thin light sheet 8, a ninth thin light sheet 9, a tenth thin light sheet 10, and a first thin light sheet 1 in order from left to right;
outer side surfaces of the first thin light sheets 1, the second thin light sheets 2, the third thin light sheets 3, the fourth thin light sheets 4, the fifth thin light sheets 5, the sixth thin light sheets 6, the seventh thin light sheets 7, the eighth thin light sheets 8, the ninth thin light sheets 9, and the tenth thin light sheets 10 are all continuous lens arrays, and inner side surfaces of the first thin light sheets 1, the second thin light sheets 2, the third thin light sheets 3, the fourth thin light sheets 4, the fifth thin light sheets 5, the sixth thin light sheets 6, the seventh thin light sheets 7, the eighth thin light sheets 8, the ninth thin light sheets 9, and the tenth thin light sheets 10 are all continuous sawtooth gratings;
an angle β1 between a sawtooth line of a sawtooth grating on an inner surface of the first thin light sheet 1 and a horizontal plane is 50°;
an angle β2 between a sawtooth line of a sawtooth grating on an inner surface of the second thin light sheet 2 and a horizontal plane is 30°;
an angle β3 between a sawtooth line of a sawtooth grating on an inner surface of the third thin light sheet 3 and a horizontal plane is 20°;
an angle β4 between a sawtooth line of a sawtooth grating on an inner surface of the fourth thin light sheet 4 and a horizontal plane is 10°;
an angle β5 between a sawtooth line of a sawtooth grating on an inner surface of the fifth thin light sheet 5 and a horizontal plane is 5°;
an angle β6 between a sawtooth line of a sawtooth grating on an inner surface of the sixth thin light sheet 6 and a horizontal plane is 175°;
an angle β7 between a sawtooth line of a sawtooth grating on an inner surface of the seventh thin light sheet 7 and a horizontal plane is 170°;
an angle β8 between a sawtooth line of a sawtooth grating on an inner surface of the eighth thin light sheet 8 and a horizontal plane is 160°;
an angle β9 between a sawtooth line of a sawtooth grating on an inner surface of the ninth thin light sheet 9 and a horizontal plane is 150°; and
an angle β10 between a sawtooth line of a sawtooth grating on an inner surface of the tenth thin light sheet 10 and a horizontal plane is 130°.

Specific Embodiment 2: this embodiment will be described in conjunction with FIGS. 1-13, and the continuous lens arrays of the combined monolithic uniform lighting device based on light sheets and sawtooth gratings provided in this embodiment includes refer to continuous concave lens arrays. Other components and connection relationships are the same as those in Specific Embodiment 1.

Specific Embodiment 3: this embodiment will be described in conjunction with FIGS. 1-13, and a thickness z₁ of different positions x₁ and y₁ on a surface of each concave lens of the continuous concave lens arrays of the combined monolithic uniform lighting device based on light sheets and sawtooth gratings provided in this embodiment is expressed as

$${z}_{1} = - \frac{{x}_{1}^{2} + {y}_{1}^{2}}{{r}_{1} + \sqrt{{r}_{1}^{2} - ( {x}_{1}^{2} + {y}_{1}^{2} )}} ,$$

where r₁ is a radius of curved surface of a concave lens, and the radius of curved surface is 1-5 times a minimum spacing between the concave lens and a sawtooth grating. Other components and connection relationships are the same as those in Specific Embodiment 2.

Specific Embodiment 4: this embodiment will be described in conjunction with FIGS. 1-13, and a phase modulation φ₁ added to natural light by the continuous concave lens arrays of the combined monolithic uniform lighting device based on light sheets and sawtooth gratings provided in this embodiment is expressed as

$${φ}_{1} = - \frac{π ( {x}_{3}^{2} + {y}_{3}^{2} )}{λ f} ,$$

where x₃ and y₃ are positions of an incident wavefront of the lens arrays, λ represents a center wavelength of the natural light, and f represents a focal length of the lens. Other components and connection relationships are the same as those in Specific Embodiment 2.

Specific Embodiment 5: this embodiment will be described in conjunction with FIGS. 1-13, and the continuous lens arrays of the combined monolithic uniform lighting device based on light sheets and sawtooth gratings provided in this embodiment includes refer to continuous convex free-form surface lens arrays. Other components and connection relationships are the same as those in Specific Embodiment 1.

Specific Embodiment 6: this embodiment will be described in conjunction with FIGS. 1-13, and a thickness d₁ of different positions x₁ and y₁ on each convex free-form surface of the continuous convex free-form surface lens arrays of the combined monolithic uniform lighting device based on light sheets and sawtooth gratings provided in this embodiment is expressed as

$${d}_{1} ( {x}_{1} , {y}_{1} ) = \frac{1}{n - 1} ( \frac{{x}_{1}^{2} + {y}_{1}^{2}}{{r}_{1} + \sqrt{{r}_{1}^{2} + ( {x}_{1}^{2} + {y}_{1}^{2} )}} + {y}_{1} \cdot sin {θ}_{1} ) ,$$

where n represents a refractive index, r₁ represents a radius of curvature at a vertex of the convex free-form surface, and θ₁ represents a surface-type inclination angle of the convex free-form surface, which makes the light propagate in a horizontal direction through refraction, and the radius of curvature is 1-5 times a minimum spacing between the free-form surface and the sawtooth grating. Other components and connection relationships are the same as those in Specific Embodiment 5.

Specific Embodiment 7: this embodiment will be described in conjunction with FIGS. 1-13, and a phase modulation φ₁ added to incident light by the continuous convex free-form surface lens arrays of the combined monolithic uniform lighting device based on light sheets and sawtooth gratings provided in this embodiment is expressed as

$${φ}_{1} = - \frac{π ( {x}_{3}^{2} + {y}_{3}^{2} )}{λ {f}_{1}} - \frac{2 π}{λ} {y}_{3} \cdot sin {θ}_{3} ,$$

where θ₃ represents an incident angle of the natural light on the free-form surface, λ represents a center wavelength of the incident light, f₁represents an equivalent focal length of the free-form surface, and x₃ and y₃ are positions of an incident wavefront of free-form surface arrays. Other components and connection relationships are the same as those in Specific Embodiment 5.

Specific Embodiment 8: this embodiment will be described in conjunction with FIGS. 1-13, and a phase modulation φ₂ added to incident natural light by the continuous sawtooth gratings of the combined monolithic uniform lighting device based on light sheets and sawtooth gratings provided in this embodiment is expressed as

$${φ}_{2} = - \frac{2 π}{λ} {y}_{4} \cdot sin {θ}_{4} ,$$

where y₄ represents a position of an incident wavefront of the sawtooth surface array, and θ₄ represents an incident angle of natural light on a sawtooth surface. Other components and connection relationships are the same as those in Specific Embodiment 1.

Specific Embodiment 9: this embodiment will be described in conjunction with FIGS. 1-13, and the first thin light sheets 1, the second thin light sheets 2, the third thin light sheets 3, the fourth thin light sheets 4, the fifth thin light sheets 5, the sixth thin light sheets 6, the seventh thin light sheets 7, the eighth thin light sheets 8, the ninth thin light sheets 9 and the tenth thin light sheets 10 of the combined monolithic uniform lighting device based on light sheets and sawtooth gratings provided in this embodiment are all made of transparent materials with a transmittance greater than 85%. Other components and connection relationships are the same as those in Specific Embodiment 1.

Specific Embodiment 10: this embodiment will be described in conjunction with FIGS. 1-13, each lens of the continuous lens arrays corresponds to each sawtooth of the sawtooth gratings of the continuous sawtooth gratings of the combined monolithic uniform lighting device based on light sheets and sawtooth gratings provided in this embodiment, a center position of the sawtooth matches an optical axis of the lens, and a range of a sawtooth inclination angle of the continuous gratings θ is 20°-70°. Other components and connection relationships are the same as those in Specific Embodiment 1.

### Working Principle

The present invention includes a front surface and a rear surface in an array form, a front surface is a lens array, and a rear surface is a sawtooth surface array; outdoor natural light at a high angle is collected by the lens array surface, and transmitted to the sawtooth surface array through the intermediate medium made of the same material between the two surfaces, and then horizontally dispersed to the indoor space after being refracted by an inclined surface.

The above description is merely preferred embodiments of the present invention, and is not intended to limit the present invention in any form. Although the present invention has been disclosed in preferred embodiments, but they are not intended to limit the present invention. Without departing from the scope of the technical solution of the present invention, anyone skilled in the art may make many possible changes and modifications to the technical solution of the present invention by using the above disclosed technical contents. Any simple alteration, equivalent change and improvement which are made to the above embodiments in accordance with the technical essence of the present invention without departing from the contents of the technical solutions of the present invention shall fall within the scope of protection scope of the technical solution of the present invention.

What is claimed is:

1. A combined monolithic uniform lighting device based on lenses and sawtooth gratings, wherein the device comprises ten first thin light sheets (1), ten second thin light sheets (2), ten third thin light sheets (3), ten fourth thin light sheets (4), ten fifth thin light sheets (5), ten sixth thin light sheets (6), ten seventh thin light sheets (7), ten eighth thin light sheets (8), ten ninth thin light sheets (9) and ten tenth thin light sheets (10), which are arranged in a matrix to form a daylighting matrix;
a first row of the daylighting matrix comprises a first thin light sheet (1), a second thin light sheet (2), a third thin light sheet (3), a fourth thin light sheet (4), a fifth thin light sheet (5), a sixth thin light sheet (6), a seventh thin light sheet (7), an eighth thin light sheet (8), a ninth thin light sheet (9), and a tenth thin light sheet (10) in order from left to right;
a second row of the daylighting matrix comprises a tenth thin light sheet (10), a first thin light sheet (1), a second thin light sheet (2), a third thin light sheet (3), a fourth thin light sheet (4), a fifth thin light sheet (5), a sixth thin light sheet (6), a seventh thin light sheet (7), an eighth thin light sheet (8), and a ninth thin light sheet (9) in order from left to right;
a third row of the daylighting matrix comprises a ninth thin light sheet (9), a tenth thin light sheet (10), a first thin light sheet (1), a second thin light sheet (2), a third thin light sheet (3), a fourth thin light sheet (4), a fifth thin light sheet (5), a sixth thin light sheet (6), a seventh thin light sheet (7), and an eighth thin light sheet (8) in order from left to right;
a fourth row of the daylighting matrix comprises an eighth thin light sheet (8), a ninth thin light sheet (9), a tenth thin light sheet (10), a first thin light sheet (1), a second thin light sheet (2), a third thin light sheet (3), a fourth thin light sheet (4), a fifth thin light sheet (5), a sixth thin light sheet (6), and a seventh thin light sheet (7) in order from left to right;
a fifth row of the daylighting matrix comprises a seventh thin light sheet (7), an eighth thin light sheet (8), a ninth thin light sheet (9), a tenth thin light sheet (10), a first thin light sheet (1), a second thin light sheet (2), a third thin light sheet (3), a fourth thin light sheet (4), a fifth thin light sheet (5), and a sixth thin light sheet (6) in order from left to right;
a sixth row of the daylighting matrix comprises a sixth thin light sheet (6), a seventh thin light sheet (7), an eighth thin light sheet (8), a ninth thin light sheet (9), a tenth thin light sheet (10), a first thin light sheet (1), a second thin light sheet (2), a third thin light sheet (3), a fourth thin light sheet (4), and a fifth thin light sheet (5) in order from left to right;
a seventh row of the daylighting matrix comprises a fifth thin light sheet (5), a sixth thin light sheet (6), a seventh thin light sheet (7), an eighth thin light sheet (8), a ninth thin light sheet (9), a tenth thin light sheet (10), a first thin light sheet (1), a second thin light sheet (2), a third thin light sheet (3), and a fourth thin light sheet (4) in order from left to right;
an eighth row of the daylighting matrix comprises a fourth thin light sheet (4), a fifth thin light sheet (5), a sixth thin light sheet (6), a seventh thin light sheet (7), an eighth thin light sheet (8), a ninth thin light sheet (9), a tenth thin light sheet (10), a first thin light sheet (1), a second thin light sheet (2), and a third thin light sheet (3) in order from left to right;
a ninth row of the daylighting matrix comprises a third thin light sheet (3), a fourth thin light sheet (4), a fifth thin light sheet (5), a sixth thin light sheet (6), a seventh thin light sheet (7), an eighth thin light sheet (8), a ninth thin light sheet (9), a tenth thin light sheet (10), a first thin light sheet (1), and a second thin light sheet (2) in order from left to right;
a tenth row of the daylighting matrix comprises a second thin light sheet (2), a third thin light sheet (3), a fourth thin light sheet (4), a fifth thin light sheet (5), a sixth thin light sheet (6), a seventh thin light sheet (7), an eighth thin light sheet (8), a ninth thin light sheet (9), a tenth thin light sheet (10), and a first thin light sheet (1) in order from left to right;
outer side surfaces of the first thin light sheets (1), the second thin light sheets (2), the third thin light sheets (3), the fourth thin light sheets (4), the fifth thin light sheets (5), the sixth thin light sheets (6), the seventh thin light sheets (7), the eighth thin light sheets (8), the ninth thin light sheets (9), and the tenth thin light sheets (10) are all continuous lens arrays, and inner side surfaces of the first thin light sheets (1), the second thin light sheets (2), the third thin light sheets (3), the fourth thin light sheets (4), the fifth thin light sheets (5), the sixth thin light sheets (6), the seventh thin light sheets (7), the eighth thin light sheets (8), the ninth thin light sheets (9), and the tenth thin light sheets (10) are all continuous sawtooth gratings;
an angle (β1) between a sawtooth line of a sawtooth grating on an inner surface of the first thin light sheet (1) and a horizontal plane is 50°;
an angle (β2) between a sawtooth line of a sawtooth grating on an inner surface of the second thin light sheet (2) and a horizontal plane is 30°;
an angle (β3) between a sawtooth line of a sawtooth grating on an inner surface of the third thin light sheet (3) and a horizontal plane is 20°;
an angle (β4) between a sawtooth line of a sawtooth grating on an inner surface of the fourth thin light sheet (4) and a horizontal plane is 10°;
an angle (β5) between a sawtooth line of a sawtooth grating on an inner surface of the fifth thin light sheet (5) and a horizontal plane is 5°;
an angle (β6) between a sawtooth line of a sawtooth grating on an inner surface of the sixth thin light sheet (6) and a horizontal plane is 175°;
an angle (β7) between a sawtooth line of a sawtooth grating on an inner surface of the seventh thin light sheet (7) and a horizontal plane is 170°;
an angle (β8) between a sawtooth line of a sawtooth grating on an inner surface of the eighth thin light sheet (8) and a horizontal plane is 160°;
an angle (β9) between a sawtooth line of a sawtooth grating on an inner surface of the ninth thin light sheet (9) and a horizontal plane is 150°; and
an angle (β10) between a sawtooth line of a sawtooth grating on an inner surface of the tenth thin light sheet (10) and a horizontal plane is 130°.

2. The combined monolithic uniform lighting device based on lenses and sawtooth gratings according to claim 1, wherein the continuous lens arrays refer to continuous concave lens arrays.

3. The combined monolithic uniform lighting device based on lenses and sawtooth gratings according to claim 2, wherein a thickness z₁ of different positions x₁ and y₁ on a surface of each concave lens of the continuous concave lens arrays is expressed as
$${z}_{1} = - \frac{{x}_{1}^{2} + {y}_{1}^{2}}{{r}_{1} + \sqrt{{r}_{1}^{2} - ( {x}_{1}^{2} + {y}_{1}^{2} )}} ,$$
wherein r₁ is a radius of curved surface of a concave lens, and the radius of curved surface is 1-5 times a minimum spacing between the concave lens and a sawtooth grating.

4. The combined monolithic uniform lighting device based on lenses and sawtooth gratings according to claim 2, wherein a phase modulation φ₁ added to natural light by the continuous concave lens arrays is expressed as
$${φ}_{1} = - \frac{π ( {x}_{3}^{2} + {y}_{3}^{2} )}{λ f} ,$$
wherein x₃ and y₃ are positions of an incident wavefront of the lens arrays, λ represents a center wavelength of the natural light, and f represents a focal length of the lens.

5. The combined monolithic uniform lighting device based on lenses and sawtooth gratings according to claim 1, wherein the continuous lens arrays refer to continuous convex free-form surface lens arrays.

6. The combined monolithic uniform lighting device based on lenses and sawtooth gratings according to claim 5, wherein a thickness d₁ of different positions x₁ and y₁ on each convex free-form surface of the continuous convex free-form surface lens arrays is expressed as
$${d}_{1} ( {x}_{1} , {y}_{1} ) = \frac{1}{n - 1} ( \frac{{x}_{1}^{2} + {y}_{1}^{2}}{{r}_{1} + \sqrt{{r}_{1}^{2} + ( {x}_{1}^{2} + {y}_{1}^{2} )}} + {y}_{1} \cdot sin {θ}_{1} ) ,$$
wherein n represents a refractive index, r₁ represents a radius of curvature at a vertex of the convex free-form surface, and θ₁ represents a surface-type inclination angle of the convex free-form surface, which makes the light propagate in a horizontal direction through refraction, and the radius of curvature is 1-5 times a minimum spacing between the free-form surface and the sawtooth grating.

7. The combined monolithic uniform lighting device based on lenses and sawtooth gratings according to claim 5, wherein a phase modulation φ₁ added to incident light by the continuous convex free-form surface lens arrays is expressed as
$${φ}_{1} = - \frac{π ( {x}_{3}^{2} + {y}_{3}^{2} )}{λ {f}_{1}} - \frac{2 π}{λ} {y}_{3} \cdot sin {θ}_{3} ,$$
wherein θ₃ represents an incident angle of the natural light on the free-form surface, λ represents a center wavelength of the incident light, f₁ represents an equivalent focal length of the free-form surface, and x₃ and y₃ are positions of an incident wavefront of free-form surface arrays.

8. The combined monolithic uniform lighting device based on lenses and sawtooth gratings according to claim 1, wherein a phase modulation φ₂ added to incident natural light by the continuous sawtooth gratings is expressed as
$${φ}_{2} = - \frac{2 π}{λ} {y}_{4} \cdot sin {θ}_{4} ,$$
wherein y₄ represents a position of an incident wavefront of the sawtooth surface array, and θ₄ represents an incident angle of natural light on a sawtooth surface.

9. The combined monolithic uniform lighting device based on lenses and sawtooth gratings according to claim 1, wherein the first thin light sheets (1), the second thin light sheets (2), the third thin light sheets (3), the fourth thin light sheets (4), the fifth thin light sheets (5), the sixth thin light sheets (6), the seventh thin light sheets (7), the eighth thin light sheets (8), the ninth thin light sheets (9) and the tenth thin light sheets (10) of the combined monolithic uniform lighting device based on light sheets and sawtooth gratings provided in this embodiment are all made of transparent materials with a transmittance greater than 85%.

10. The combined monolithic uniform lighting device based on lenses and sawtooth gratings according to claim 1, wherein each lens of the continuous lens arrays corresponds to each sawtooth of the sawtooth gratings of the continuous sawtooth gratings, a center position of the sawtooth matches an optical axis of the lens, and a range of an sawtooth inclination angle of the continuous gratings θ is 20°-70°.
